(19) United States
(12) Patent Application Publication
(10) Pub. No.: US 2022/0183536 A1
(43) Pub. Date: Jun. 16, 2022

(54) Knife Cleaning Device

(71) Applicant: Lori Willeford, Beeville, TX (US)

(72) Inventor: Lori Willeford, Beeville, TX (US)

(21) Appl. No.: 17/540,558

(22) Filed: Dec. 2, 2021

Related U.S. Application Data
(60) Provisional application No. 63/125,043, filed on Dec. 14, 2020.

(51) Int. Cl. A47L 17/00; B26B 3/00

(52) U.S. Cl. CPC A47L 17/00; B26B 3/00

(57) ABSTRACT

The present invention relates to a knife cleaning device with a body that is primarily comprised of a top surface and a generally parallel bottom surface, a pair of generally parallel side surfaces, wherein at least one side surface of the pair has at least one handle assembly, a generally parallel front surface and rear surface and an interior cavity. The front surface and rear surface are each further comprised of a generally rectangular opening, connected by the interior cavity that receives a blade of a knife. The device can be applied to the blade of the knife and pushed to the rear of the knife, wherein the device can be slid forward along the blade using the handle assembly to dislodge the food from the blade.

### CROSS-REFERENCE TO RELATED APPLICATION

The present application claims priority to, and the benefit of, U.S. Provisional Application No. 63/125,043, which was filed on Dec. 14, 2020 and is incorporated herein by reference in its entirety.

### FIELD OF THE INVENTION

The present invention relates generally to the field of knives. More specifically, the present invention relates to a knife cleaning device with a body that is primarily comprised of a top surface and a generally parallel bottom surface, a pair of generally parallel side surfaces wherein at least one side surface of the pair has at least one handle assembly, a generally parallel front surface and rear surface and an interior cavity. The front surface and rear surface are each further comprised of a generally rectangular opening connected by the interior cavity that receives a blade of a knife. Before chopping, cutting or slicing with a knife, the device can be applied to the blade of the knife and pushed to the rear of the knife. The knife can then be used as normal to chop, slice or cut food. When food sticks to the blade of the knife, the device can be slid forward along the blade using the handle assembly to dislodge the food from the blade. After successfully removing said food from the blade, the device can then be slid backwards and returned to the rear of the blade to allow the knife to be used to continue chopping, cutting or slicing food. Accordingly, the present disclosure makes specific reference thereto. Nonetheless, it is to be appreciated that aspects of the present invention are also equally applicable to other like applications, devices and methods of manufacture.

### BACKGROUND

Many individuals enjoying cooking as a pastime or a profession. While cooking, it is common to slice, cut, and chop food ingredients for a recipe using a knife. When chopping, slicing or cutting food with a knife, excess food may cling to the knife. Because leaving said food on the knife would be wasteful, and also impair the function of the knife, the knife must then be cleaned. To accomplish this, many individuals will attempt to use their hands, paper towels or other methods to remove said food from the knife. However, these methods can be incredibly dangerous, as a user's hand or fingers may slip and become severely cut by the knife blade while trying to remove the excess food stuck to the blade.

Therefore, there exists a long-felt need in the art for a device that allows a user to remove excess food that is stuck to a knife while cooking. There also exists a long-felt need in the art for a knife cleaning device that allows a user to remove excess food that is stuck to a knife while cooking that also prevents the user from being cut by the knife while doing so. In addition, there exists a long-felt need in the art for a knife cleaning device that allows a user to remove excess food that is stuck to a knife while cooking and that prevents a user from being cut by the knife, wherein the device can be universally applied to any knife of any style.

The subject matter disclosed and claimed herein, in one embodiment thereof, comprises a knife cleaning device. The device has a body that is primarily comprised of a top surface and a generally parallel bottom surface, a pair of generally parallel side surfaces wherein at least one side surface of the pair has at least one handle assembly, a generally parallel front surface and rear surface and an interior cavity. The front surface and rear surface are each further comprised of a generally rectangular opening connected by the interior cavity that receives a blade of a knife. Before chopping, cutting or slicing with a knife, the device can be applied to the blade of the knife and pushed to the rear of the knife. The knife can then be used as normal to chop, slice or cut food. When food sticks to the blade of the knife, the device can be slid forward along the blade using the handle assembly to dislodge the food from the blade. After successfully removing said food from the blade, the device can then be slid backwards and returned to the rear of the blade to allow the knife to be used to continue chopping, cutting or slicing food.

In this manner, the knife cleaning device of the present invention accomplishes all of the forgoing objectives and allows a user to safely remove excess food that is stuck to a knife while cooking. While doing so, the device also prevents a user from being cut by the knife. The device also can be universally applied to any knife of any style, making it extremely practical and versatile.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a knife cleaning device. The device has a body that is primarily further comprised of a top surface and a generally parallel bottom surface, a pair of generally parallel side surfaces, wherein at least one side surface of the pair has at least one handle assembly, a generally parallel front surface and rear surface, and an interior cavity. In the preferred embodiment, the body is manufactured from a washable, reusable, rigid, plastic material. However, portions of or the entire body may be manufactured from a durable metal such as, but not limited to, stainless steel or aluminum. In the preferred embodiment the body is generally rectangular in shape with rounded corners and edges. The dimensions of the body and/or openings may be sized appropriately to allow the device to be applied to and used with any knife of any knife-type and size known in the art.

The front surface and rear surface are each comprised of a generally rectangular continuous opening that are connected by a rectangular interior cavity that is preferably manufactured from a plastic material or a rubber material. In any embodiment, the material that makes up the cavity preferably has a low coefficient of friction, such that a blade of a knife can then be inserted through the body via the openings and cavity via first inserting the blade through the opening of the rear surface, through the cavity, and then through the opening of the front surface. In this manner, the tip of the blade extends away from the front surface of the body.

At least one side surface is further comprised of a handle assembly that may be fixedly or removably-attached to the side surface. In differing embodiments, the handle body of the assembly may be generally rectangular in shape or may be spherical with a stem. It should be appreciated that in any embodiment, the shape of the handle body may be any shape known in the art that can be grasped by a hand and/or fingers of a user. Any surface of the handle body may also have a textured grip surface that promotes grip.

To use the device, a user first inserts a knife blade through the body as described above while grasping the handle body with the hand and/or fingers. Then, using the handle body the device can be slid along the blade to the rear of the blade. The knife can then be used as normal to chop food. Once said food has been chopped, the device can be slid forward on the blade in a direction towards the tip, via grasping the handle body using a hand and/or fingers. As the device is slid forward (e.g. towards the tip from the rear) the front surface dislodges any food that remains on the side surfaces, top edge, and/or bottom edge of the blade. Once all food has been dislodged, the device can then once again be slid to the rear of the blade and the knife can once again be used to chop food until the device needs to be used again.

Accordingly, the knife cleaning device of the present invention is particularly advantageous, as it allows a user to safely remove excess food that is stuck to a knife while cooking. In doing so, the device also prevents a user from being cut by the knife. The device also can be universally applied to any knife of any style and as such is extremely practical and versatile. In this manner, the knife cleaning device overcomes the limitations of existing methods of cleaning knives known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front and rear perspective view of multiple potential embodiments of a knife cleaning device of the present invention in accordance with the disclosed architecture;

FIG. 2 illustrates a perspective view of one potential embodiment of a knife cleaning device of the present invention while applied to a knife in accordance with the disclosed architecture;

FIG. 3 illustrates a perspective view of one potential embodiment of a knife cleaning device of the present invention while being used on a knife in accordance with the disclosed architecture;

FIG. 4 illustrates a perspective view of one potential embodiment of a knife cleaning device of the present invention while being used on a knife in accordance with the disclosed architecture; and

FIG. 5 illustrates a flow chart of a method of using one potential embodiment of a knife cleaning device of the present invention with a knife in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a user to remove excess food that is stuck to a knife while cooking. There also exists a long-felt need in the art for a knife cleaning device that allows a user to remove excess food that is stuck to a knife while cooking that also prevents the user from being cut by the knife while doing so. In addition, there exists a long-felt need in the art for a knife cleaning device that allows a user to remove excess food that is stuck to a knife while cooking and that prevents a user from being cut by the knife, wherein the device can be universally applied to any knife of any style.

The present invention, in one exemplary embodiment, is comprised of a knife cleaning device with a body that is further comprised of a top surface and a generally parallel bottom surface, a pair of generally parallel side surfaces wherein at least one side surface of the pair has at least one handle assembly, a generally parallel front surface and rear surface and an interior cavity. In the preferred embodiment, the body is manufactured from a washable, reusable, rigid, plastic material. However, portions of or the entire body may be manufactured from a durable metal such as, but not limited to, stainless steel or aluminum. The body is also preferably generally rectangular in shape with rounded corners and edges. Further, the dimensions of the body and/or openings may be sized appropriately to allow the device to be applied to and used with any knife of any knife-type and size known in the art.

The front surface and rear surface are each comprised of a generally rectangular continuous opening that are connected by a rectangular interior cavity. The cavity is preferably manufactured from a plastic material or a rubber material that has a low coefficient of friction such that a blade of a knife can then be inserted through the body via the openings and cavity via first inserting the blade through the opening of the rear surface, through the cavity, and then through the opening of the front surface. In this manner, the tip of the blade extends away from the front surface of the body.

At least one side surface is further comprised of a handle assembly that may be fixedly or removably-attached to the side surface. In differing embodiments, the handle body of the assembly may be generally rectangular in shape or be spherical with a stem. However, the shape of the handle body may be any shape known in the art that can be grasped by a hand and/or fingers of a user. Any surface of the handle body may also have a textured grip surface that promotes grip.

To use the device, a user first inserts a knife blade through the body as described above while grasping the handle body with the hand and/or fingers. Then, using the handle body the device can be slid along the blade to the rear of the blade. The knife can then be used as normal to chop food. Once said food has been chopped, the device can be slid forward on the blade in a direction towards the tip via grasping the handle body using a hand and/or fingers. As the device is slid forward (e.g. towards the tip from the rear) the front surface dislodges any food that remains on the side surfaces, top edge, and/or bottom edge of the blade. Once all food has been dislodged, the device can then once again be slid to the rear of the blade and the knife can once again be used to chop food until the device needs to be used again.

Accordingly, the knife cleaning device of the present invention is particularly advantageous as it allows a user to safely remove excess food that is stuck to a knife while cooking. In doing so, the device also prevents a user from being cut by the knife. The device also can be universally applied to any knife of any style and as such is extremely practical and versatile. In this manner, the knife cleaning device overcomes the limitations of existing methods of cleaning knives known in the art.

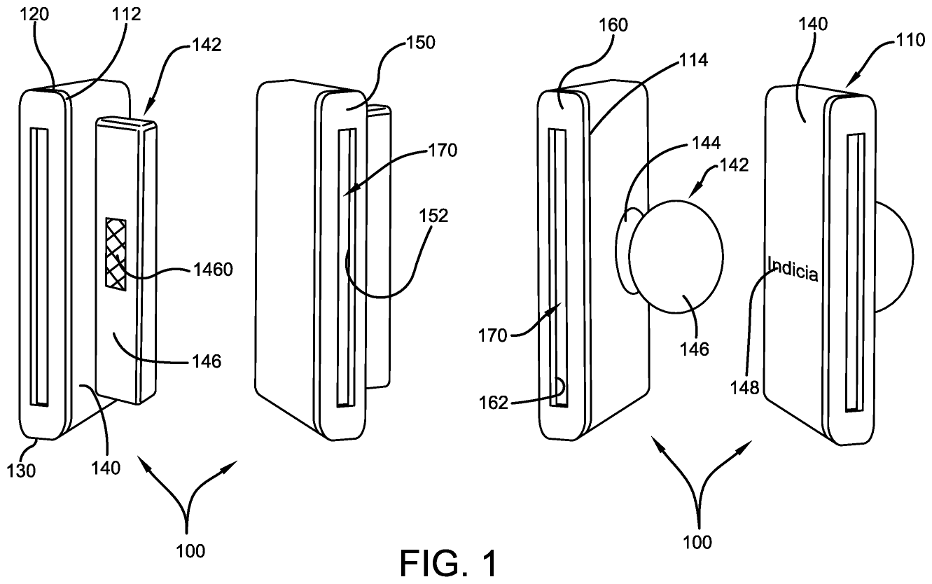

Referring initially to the drawings, FIG. 1 illustrates a front and rear perspective view of multiple potential embodiments of a knife cleaning device 100 of the present invention in accordance with the disclosed architecture. The device 100 has a body 110 that is primarily further comprised of a top surface 120 and a generally parallel bottom surface 130, a pair of generally parallel side surfaces 140 wherein at least one side surface 140 of the pair has at least one handle assembly 142, a generally parallel front surface 150 and rear surface 160, and an interior cavity 170. In the preferred embodiment, the body 110 is manufactured from a washable, reusable, rigid, plastic material such as, but not limited to, acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. However, portions of or the entire body 110 may be manufactured from a durable metal such as, but not limited to, stainless steel or aluminum. The body 110 may be any color known in the art and may be opaque, transparent or semi-transparent. Further, any surface 120, 130, 140, 150, 160 of the body 110 may have a plurality of indicia 148 such as, but not limited to, patterns, logos, emblems, images, symbols, designs, letters, words, characters, animals, advertisements, brands, etc. In the preferred embodiment, the body 110 is generally rectangular in shape with rounded corners 112 and edges 114. However, in various embodiments the body 110 may be any shape known in the art such as, but not limited to, a square, triangular, oval, circular, octagonal, hexagonal, etc. The body 110 may also have non-rounded corners 112 and non-rounded edges 114. In differing embodiments, the dimensions of the body 110 and/or openings 152, 162 may be sized appropriately to allow the device 100 to be applied to and used with any knife 10 of any knife-type and size known in the art.

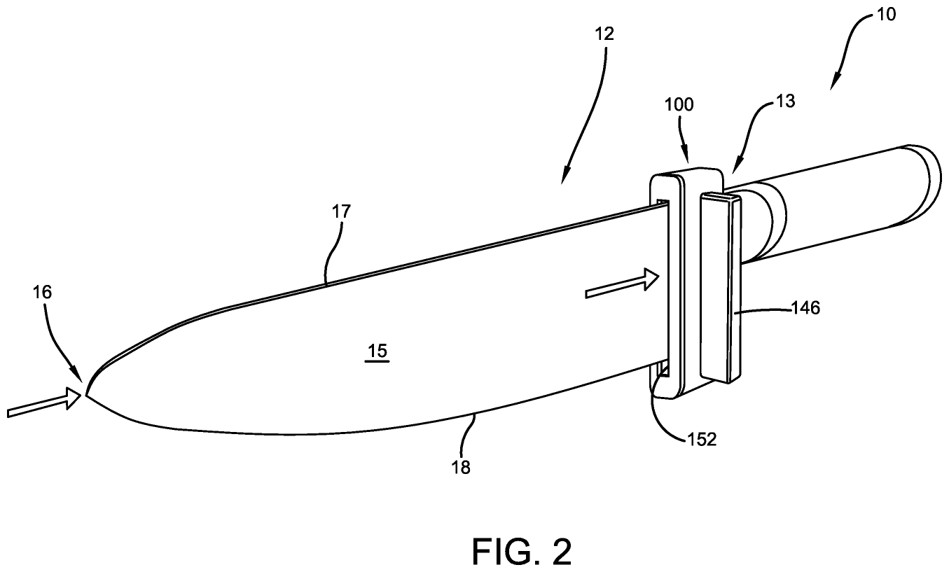

FIG. 2 illustrates a perspective view of one potential embodiment of a knife cleaning device 100 of the present invention while applied to a knife 10 (shown as prior art) in accordance with the disclosed architecture. The front surface 140 and rear surface 160 are each comprised of a generally rectangular continuous opening 152, 162. The openings 152, 162 are connected by a rectangular interior cavity 170. The cavity 170 is preferably manufactured from a plastic material mentioned above, or a rubber material. In any embodiment, the material that makes up the cavity 170 preferably has a low coefficient of friction (e.g., below 0.3 or 0.4), such that a blade 12 of a knife 10 can then be inserted through the body 110 via the openings 152, 162 and cavity 170 via first inserting the blade 12 through the opening 162 of the rear surface 160, through the cavity 170 and then through the opening 152 of the front surface 150. In this manner, the tip 16 of the blade 12 extends away from the front surface 150 of the body 110.

At least one side surface 140 is further comprised of a handle assembly 142. In differing embodiments, the handle assembly 142 may be fixedly or removably-attached to the at least one side surface 140. Further, in one embodiment the handle body 146 of the assembly 142 may be generally rectangular in shape. In another embodiment, the body 146 is spherical and has a stem 144. It should be appreciated that in any embodiment, the shape of the handle body 146 may be any shape known in the art that can be grasped by a hand 20 and/or fingers 22 of a user. To further promote grip, any surface of the handle body 146 may have a textured grip surface 1460. In differing embodiments, the surface 1460 may be comprised of a plurality of raised, rubber or metal protrusions, knurling, rubber textured-inlays, metal textured-inlays, etc., that promotes grip.

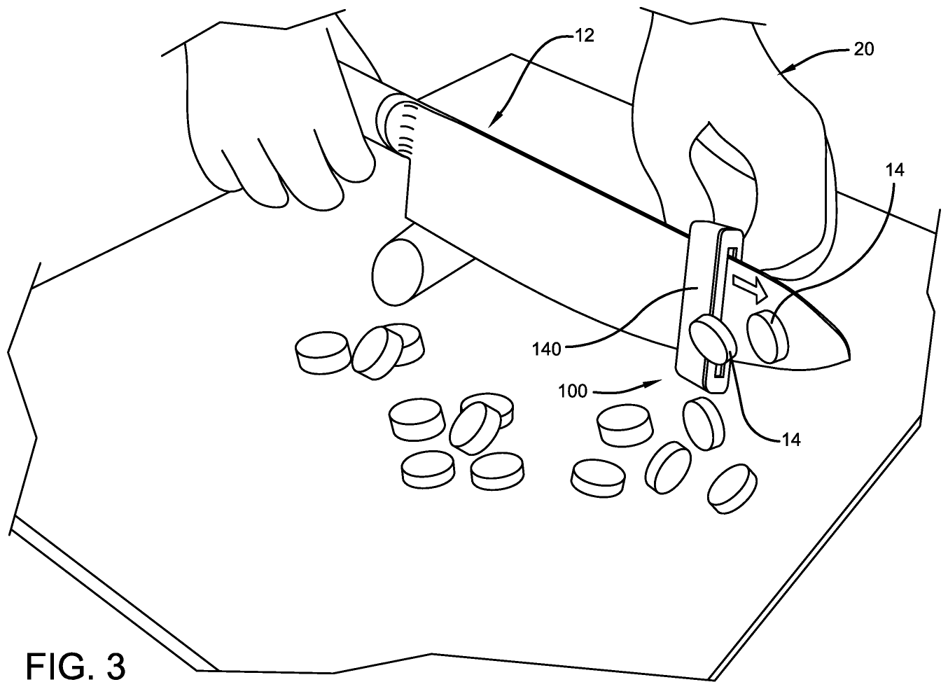

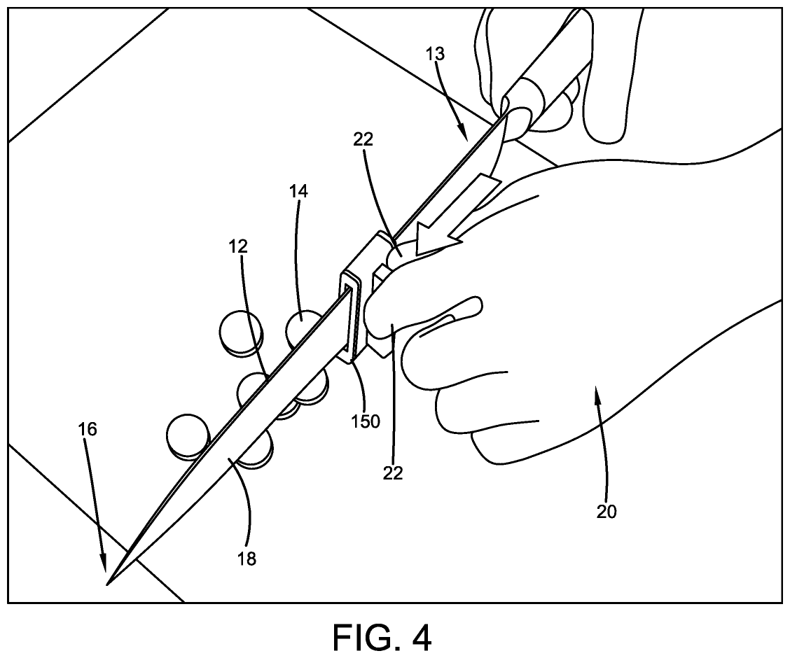

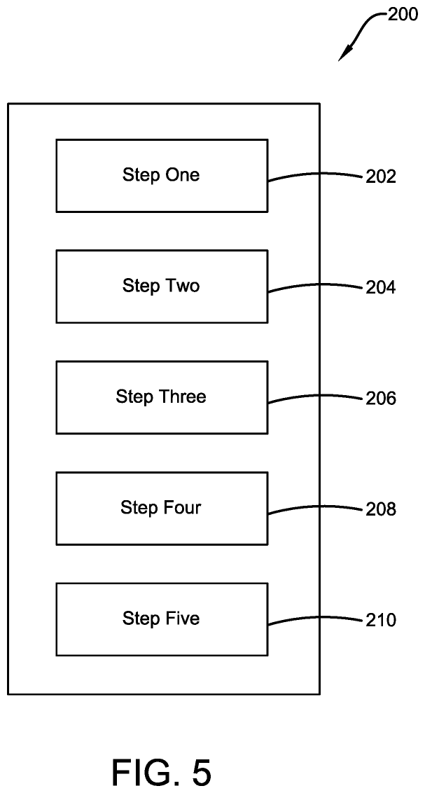

FIGS. 3 and 4 illustrate a perspective view of one potential embodiment of a knife cleaning device 100 of the present invention while being used on a knife 10 (shown as prior art) in accordance with the disclosed architecture. FIGS. 3 and 4 also serve to illustrate the device 100 being used in accordance with a method of use 200, which is described in relation to FIG. 5. To use the device 100, a user first inserts a knife 10 blade 12 through the body 110 as described supra while grasping the handle body 146 with the hand 20 and/or fingers 22 [Block 202]. Then, using the handle body 146 the device 100 can be slid along the blade 12 to the rear area 13 of the blade 12 [Block 204]. The knife 10 can then be used as normal to chop, cut or slice a food 14 [Block 206]. Once said food 14 has been chopped, the device 100 can be slid forward on the blade 12 in a direction towards the tip 16, via grasping the handle body 146 using a hand 20 and/or fingers 22 [Block 208]. As the device 100 is slid forward (e.g. towards the tip 16 from the rear 13) the front surface 150 dislodges any food 14 that remains on the side surfaces 15, top edge 17, and/or bottom edge 18 of the blade 12. Once all food 14 has been dislodged, the device 100 can then once again be slid to the rear 13 of the blade 12 and the knife 10 can once again be used to chop food 14 until the device 100 needs to be used again [Block 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “knife cleaning device” and “device” are interchangeable and refer to the knife cleaning device 100 of the present invention.

Notwithstanding the forgoing, the knife cleaning device 100 of the present invention and its various components can be of any suitable size and configuration as is known in the art without affecting the overall concept of the invention, provided that they accomplish the above-stated objectives. One of ordinary skill in the art will appreciate that the size, configuration and material of the knife cleaning device 100 as shown in the FIGS. are for illustrative purposes only, and that many other sizes and shapes of the knife cleaning device 100 are well within the scope of the present disclosure. Although the dimensions of the knife cleaning device 100 are important design parameters for user convenience, the knife cleaning device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A knife cleaning device that can be applied to a blade of a knife, the knife cleaning device comprising:
a body further comprised of:
a top surface;
a bottom surface that is generally parallel to and spaced apart from the top surface;
a pair of generally parallel side surfaces;
a front surface with an opening therein;
a rear surface with an opening therein; and
an interior cavity formed by each of the top surface, the bottom surface, the pair of generally parallel side surfaces, the front surface and the rear surface; and
a handle assembly located on at least one of the pair of generally parallel side surfaces.

2. The knife cleaning device of claim 1, wherein the body is generally rectangular in shape.

3. The knife cleaning device of claim 2, wherein the body comprises a plurality of rounded corners.

4. The knife cleaning device of claim 3, wherein the body comprises a plurality of rounded edges.

5. The knife cleaning device of claim 4, wherein the interior cavity of the body comprises a low coefficient of friction.

6. The knife cleaning device of claim 5, wherein the body is manufactured from a rubber material.

7. The knife cleaning device of claim 5, wherein the body is manufactured from a plastic material.

8. A knife cleaning device that can be applied to a blade of a knife, the knife cleaning device comprising:
a generally rectangular body further comprised of:
a top surface;
a bottom surface that is generally parallel to and spaced apart from the top surface;
a pair of generally parallel side surfaces;
a front surface;
a rear surface; and
a generally rectangular continuous opening extending between and through the front surface and the rear surface; and
a handle.

9. The knife cleaning device of claim 8, wherein the generally rectangular continuous opening is sized and configured to receive the blade of the knife.

10. The knife cleaning device of claim 8, wherein the generally rectangular body is comprised of a plastic material that is washable, reusable and rigid.

11. The knife cleaning device of claim 8, wherein the generally rectangular body has a low coefficient of friction.

12. The knife cleaning device of claim 11, wherein the generally rectangular body is comprised of a rubber material.

13. The knife cleaning device of claim 11, wherein the handle is attached to at least one of the pair of generally parallel side surfaces.

14. The knife cleaning device of claim 8, wherein the handle body is removably attached to a select one of the pair of generally parallel side surfaces.

15. The knife cleaning device of claim 14, wherein the handle is spherical in shape and is further comprised of a stem.

16. The knife cleaning device of claim 14, wherein the handle is rectangular in shape.

17. The knife cleaning device of claim 8, wherein the handle is further comprised of a textured grip surface.

18. The knife cleaning device of claim 8, wherein the generally rectangular body is comprised of a plurality of indicia.

19. A method of using a knife cleaning device comprising the steps of:
inserting a blade of a knife through a generally rectangular continuous opening in the knife cleaning device;
using a handle body of the knife cleaning device to slide the knife cleaning device along the blade of the knife to a rear area of the blade;
using the knife to chop, cut or slice a food;
sliding the knife cleaning device forward along the blade of the knife in the direction of a tip of the blade via grasping the handle body after the food has been chopped, cut or sliced; and
sliding the knife cleaning device back along the blade towards the rear area of the blade after the food has been dislodged from the blade.

20. A method of using a knife cleaning device of claim 19, wherein the handle body is removably attached to a side surface of the knife cleaning device.
